(19) United States
(12) Patent Application Publication
(10) Pub. No.: US 2008/0173852 A1
(43) Pub. Date: Jul. 24, 2008

(54) Hydraulic Jack with locking mechanism

(76) Inventors: Dave Woodbury, Layton, UT (US); Joe Otterstom, Clearfield, UT (US)

Correspondence Address: MORRISS OBRYANT COMPAGNI, P.C., 734 EAST 200 SOUTH, SALT LAKE CITY, UT, 84102, US

(21) Appl. No.: 12/009,729

(22) Filed: Jan. 22, 2008

Related U.S. Application Data
(60) Provisional application No. 60/881,408, filed on Jan. 19, 2007.

(51) Int. Cl. B66F 5/04

(52) U.S. Cl. 254/8 B

(57) ABSTRACT

The invention relates to a safety protection device to prevent a lifting mechanism of a jack from completely retracting in the case of a mechanical failure in the lifting mechanism or inadvertent operator error in prematurely releasing the lifting mechanism. The invention also relates to a safety device release mechanism allowing the operator to disengage the safety mechanism, wherein the release mechanism is preferably mountable in a location suitably remote from the lifting mechanism, for example, the release mechanism may be detachably mounted on the handle.

### CROSS-REFERENCE TO RELATED APPLICATIONS

This application claims the benefit of U.S. Provisional Patent Application No. 60/881,408, filed Jan. 19, 2007, the entirety of which is hereby incorporated by reference.

### TECHNICAL FIELD

This invention relates to a hydraulic jack having a locking mechanism.

### BACKGROUND

Various hydraulic floor jacks are known in the art and their use has become very common. However, all hydraulic systems are subject to failure or inadvertent release resulting in an undesirable, and potentially very dangerous, retracting of the lift element. As a result, people should not work under a vehicle or other lifted weight which is supported solely by a floor jack. Nevertheless, people frequently do work under vehicles held aloft solely by a floor jack. Therefore, it is highly desirable to prevent such floor jacks from retracting while in a raised position.

Examples of hydraulic floor jacks may be found in U.S. Pat. Nos. 1,767,124; 1,784,116; 1,978,451; 2,629,583; and 4,473,213.

Typically, the hydraulic pump of a floor or service jack is actuated by a handle pivotably connected to the main body of the jack. Typically, such a handle is relatively long and provides a good lever arm for actuating the hydraulic pump and thereby actuating the lifting mechanism of the jack. It would be beneficial to position a safety release mechanism on the distal end of such a handle so as to facilitate release of the safety mechanism and retraction of the jack without the need to approach dangerously close to the lifted object.

U.S. Pat. No. 5,618,029 (the '029 patent) discloses a jack safety device utilizing a safety hook and a hook-up means. However, this safety device suffers from the fact that the safety hook may not be sufficiently engaged to the hook up means at the time of a failure and would thereafter likely be ineffective in preventing complete retraction of the lifting means. For example, the hook and hook-up means of the '029 patent are both pivotally mounted at opposing ends, thereby causing the hook and/or hook-up to be at a non-optimal angle relative to one another for engagement. In addition, the hook and/or hook-up will drag on the ground beneath the jack interfering with the operators ability to position or move the jack. In contrast, the present invention utilizes a rigidly mounted pawl and ratchet system that will not contact the ground and is structured such that during a failure the locking means is more actively engaged.

U.S. Pat. No. 5,878,996 (the '996 patent) discloses a lever mechanism for disengaging the safety device of the '029 patent wherein the safety device is described as a pawl pivotably connected to the lift arm and a ratchet fastened at the front end of the main body. In both the '029 and '996 patents the distal end of the disengagement mechanism is located at the back end of the main body. Thus, when the jack is used to lift an object from a position located reasonably far from the periphery of the object, the operator will be required to approach dangerously close to the raised object to disengage the locking mechanism. Furthermore, having the pawl pivotably connected to the lift arm may result in the force vector on the pawl being exerted at an undesirable angle relative to the ratchet or hook up means, which would result in a decreased force in the locking direction. More particularly, the pawl is connected to the lift arm such that the pawl connection point rises with the lift arm, which increases the angle of the pawl relative to the ratchet, thereby decreasing the locking force. Finally, both the '029 and '966 patents describe a safety device wherein the hook or pawl is attached to the lift arm of the floor jack and the hook-up means or ratchet is connected to the front axle, thus creating a complex interaction between the length of the pawl, the length of the ratchet, the location and configuration of the front axle, and the travel distance of the hydraulic piston acting upon the lift arm.

An additional disadvantage of the configuration described in the '029 and '966 patents is that the hook or pawl of the '029 and '966 patents must extend from the lift arm by a distance greater than the travel distance of the hydraulic piston to engage the hook-up means or ratchet. As a result, when the jack is in the fully retracted position the pawl is necessarily positioned closer to the leading end of the jack in an area having less space. Therefore, the safety device of the '029 and '966 patents requires either a thinner, and structurally less sound, ratchet and pawl or a higher profile jack.

While the prior art discloses safety means for hydraulic jacks, there exists much room for safety improvement with hydraulic floor jacks.

### SUMMARY OF THE INVENTION

The invention relates to a safety protection device to prevent a lifting mechanism of a jack from completely retracting in the case of a mechanical failure in the lifting mechanism or inadvertent operator error in prematurely releasing the lifting mechanism.

The invention also relates to a safety protection device that may be fitted in a floor jack having a low profile or a floor jack lacking a front axle extending across the main body of the jack.

The invention also relates to a safety device for a jack having a pawl rigidly affixed to a main body of a jack; a ratchet rigidly affixed to a lifting arm of the jack and having a plurality of teeth configured to engage the pawl, wherein raising the lifting arm of the jack causes the ratchet to travel substantially parallel to a main body of the jack and advance past the rigidly affixed pawl as the lifting arm is raised, wherein engagement of the pawl with the teeth of the ratchet positively restricts downward movement of the lifting arm when a lifting force is removed from the lifting arm.

The invention may optionally have one or more of the following: the pawl may be biased to a ratchet engaging position, the pawl may engage the ratchet at an angle of less than or equal to about 45 degrees, the pawl may be rigidly affixed approximately equidistant between the opposing walls of the main body, the pawl may be within a ratchet and pawl housing, the pawl and/or the ratchet and pawl housing may be rigidly affixed to a main body of the jack by at least one cylindrical metal rod or at least one substantially longitudinal member, the pawl may be biased to a ratchet engaging position by counter weighting the pawl and/or by use of a spring or other elastic element, a linkage connecting the pawl to a remote actuation site, a lever arm in communication with the linkage, a remote actuation site housing, a passive guide system for the linkage system and combinations thereof.

The invention also relates to a hydraulic floor jack with a safety system, jack comprising: a hydraulic floor jack having at least two lifting arms, a hydraulic lifting system in communication with the at least two lifting arms, a main body comprising two substantially parallel outer walls and having a front end designed to face the object to be lifted and a rear end, and a handle with one end in communication with the hydraulic lifting system and a second end located distal to the main body; the main body having a rigid member extending between the two outer walls near the front end of the jack and wherein the hydraulic lifting system is located at the rear of the main body; a ratchet rigidly affixed to the at least two lifting arms and having a plurality of teeth; a pawl pivotally connected to the main body between the two substantially parallel outer walls, wherein the pawl is configured to actively engage the ratchet as the lifting arms are raised; and a linkage cable connecting the pawl to a housing located on the distal end of the handle.

The invention also relates to a safety device release mechanism allowing the operator to facilitate release of the safety device and retraction of the lifting mechanism, wherein the release mechanism is preferably mountable in a location suitably remote from the lifting mechanism. In an exemplary embodiment the invention relates to a release mechanism mountable on a portion of the handle distal from the lifting mechanism, thereby allowing the operator of the jack to release the safety device at a safe distance from the jack. Optionally, the release mechanism may be detachably mounted on the handle.

### BRIEF DESCRIPTION OF THE DRAWINGS

FIG. 1 is a perspective view in partial cutaway of an exemplary embodiment of the present invention.

FIG. 2A is a perspective view in partial cutaway of an exemplary embodiment of the present invention illustrating a cross-bar 11 means for attaching the ratchet and pawl housing 8 to the main body 1 of the jack.

FIG. 2B is a perspective view in partial cutaway of an exemplary embodiment of the present invention illustrating a rigid planer plate 11 means for attaching the ratchet and pawl housing 8 to the main body 1.

FIG. 3 is a schematical representation of the ratchet 6, pawl 7, and ratchet and pawl housing 8, along with the release mechanism 16.

FIG. 4 is a side view of a ratchet 6 adapted for installation in a pre-assembled jack.

FIG. 5 is a side view of an exemplary embodiment of the present invention.

FIG. 6 is a perspective view of an exemplary embodiment of the present invention.

FIG. 7 is a bottom view of an exemplary embodiment of the present invention showing the underside of the jack and a method of connecting the locking mechanism or pawl to a substantially longitudinal member connected to the bottom surface of the outer walls of the main body of the jack.

### DETAILED DESCRIPTION OF THE INVENTION

By way of example, the locking mechanism and release mechanism are described in view of a hydraulic floor or service jack, however, as will be recognized in view of the present specification, the present device may be adapted to other types of jacks having a lifting arm or lever as a component of the lifting mechanism.

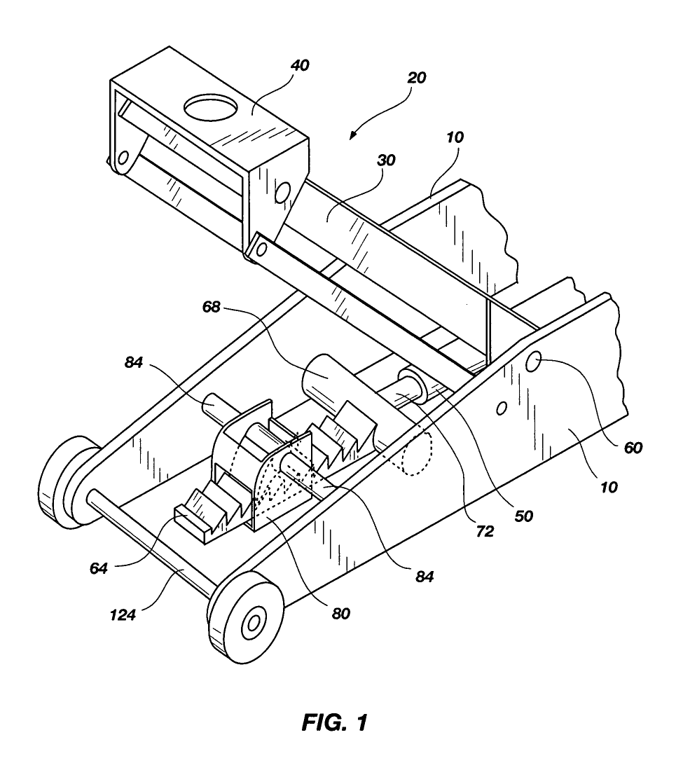

Referring to FIG. 1, the present jack comprises a main body 10, a holding mechanism 20 having a pair of lifting arms 30 connected to the main body 10, with the top end of the holding mechanism 20 having a holding portion 40 for lifting an object, and a lifting mechanism 50 for driving the lifting arms 30 upwardly about a pivot point 60 with the holding portion 40 supporting the object being lifted (for example, see, U.S. Pat. No. 4,289,299).

In the exemplary embodiment illustrated in FIG. 1, the present safety device comprises a ratchet 64 rigidly connected to a bar 68 on the end of the ram 72, where the bar 68 is then connected to the lifting arms 30 (not shown). In this particular configuration, the bar 68 transfers the force and motion of the ram 72 to the lifting arms 30, and comprises part of the lifting mechanism 50. In FIG. 1 a pawl 76 is illustrated inside a ratchet and pawl housing 80, which is rigidly connected to the main body 10, wherein raising the lifting arms 30 (i.e., extending the ram 72) drives the ratchet 64 past the pawl 76. The engagement of the pawl 76 with the ratchet 64 then prevents retraction of the lifting arms 30 and/or lifting mechanism 50 upon failure of the lifting mechanism 50 or inadvertent release of the pressure in lifting mechanism 50. To release the safety mechanism (ratchet 64 and pawl 76), the operator manually disengages the pawl 76 from the ratchet 64.

Optimally the pawl 76 is connected to the main body 10 at a point proximal to the maximum extension point of the bar 68 and/or ram 72 of the lifting mechanism 50. In this position the pawl 76 does not restrict the motion of the lifting arms 30. In addition, the length of the ratchet 64 may be configured such that the ratchet 64 does not limit the maximum extension point of the bar 68 and/or ram 72.

While the jack illustrated in FIG. 1 uses a bar 68 to transmit a lifting force to the lifting arms 30, this is only one configuration commonly used in floor jacks. For example, U.S. Pat. Nos. 3,181,836 and 5,201,494 illustrate other configurations. In another exemplary embodiment, the ratchet 64 is connected directly or indirectly to the ram 72 of the lifting mechanism, so as to prevent retraction of the lifting arms 30.

The jack illustrated in FIG. 1 has a main body 10 that is made up of two opposing walls and an axle between the two opposing walls.

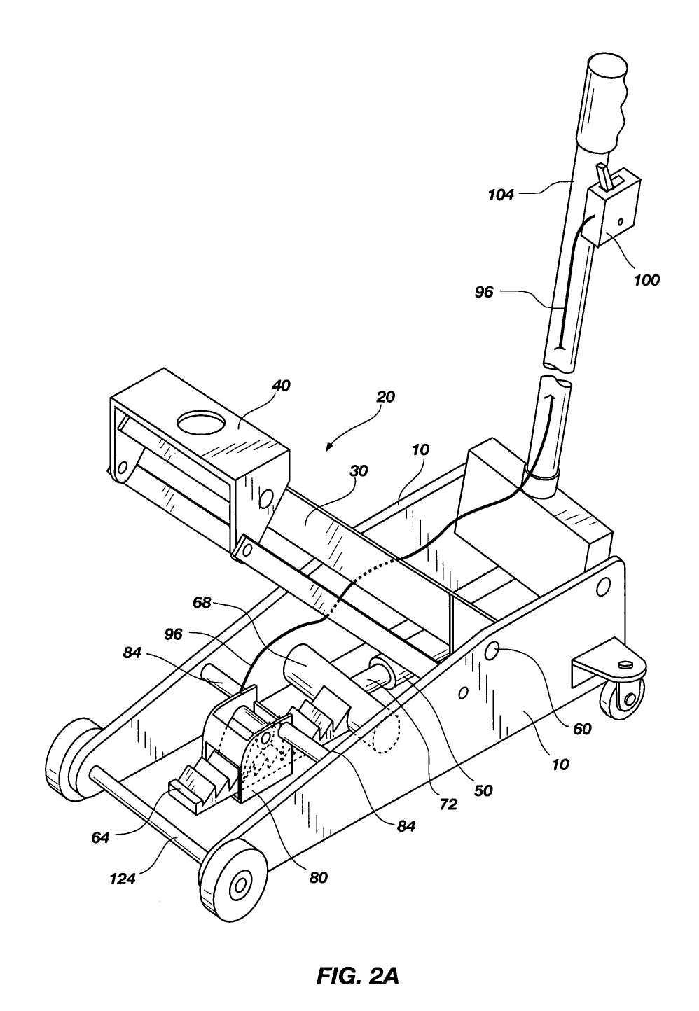

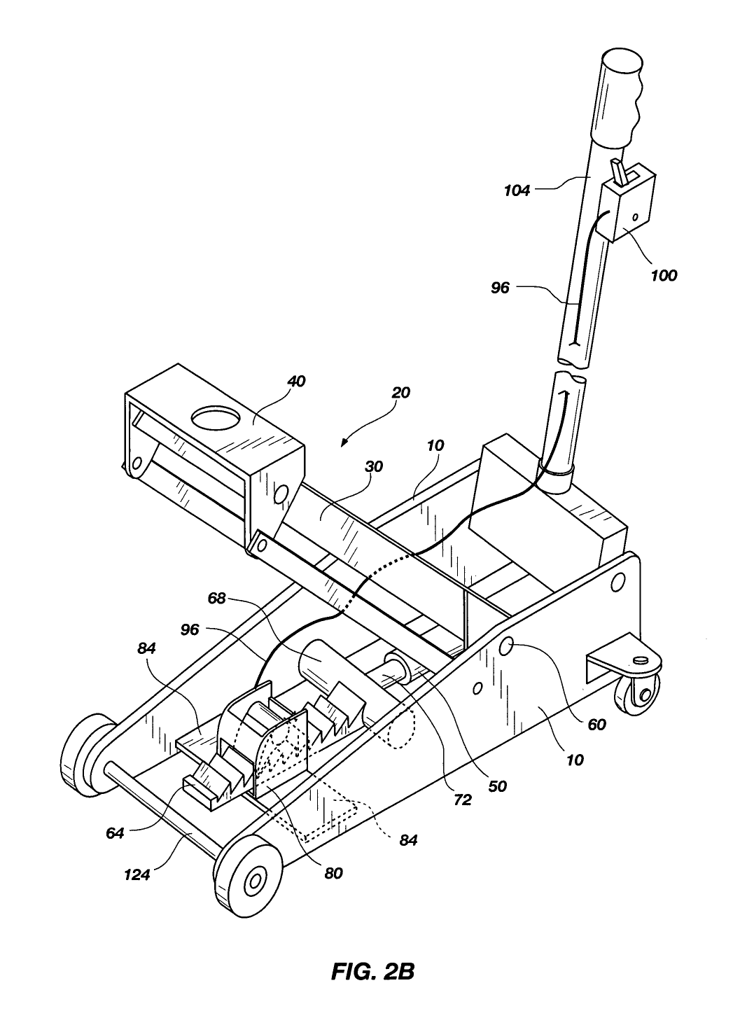

In an exemplary embodiment, illustrated in FIG. 1, the pawl 76 is rotatably connected to a cross-brace 84 and thereby connected to the main body 10. Since the pawl 76 is held in a fixed position relative to the main body 10, retraction of the ratchet 64 is prevented by the pawl 76 and the lift arms 30 cannot be lowered without disengaging the pawl 76 from the ratchet 64. FIGS. 2A and 2B illustrate other exemplary embodiments wherein the ratchet and pawl housing 80 is connected to the main body 10 by other means. For example, in FIG. 2A the ratchet and pawl housing 80 is connected to the main body 10 by way of a cross-brace 84 made up of one or more ridged members. In FIG. 2A the cross-braces 84′ connect to the ratchet an pawl housing 80 at a location other than the pivotal connection point between the ratchet and pawl housing 80 and pawl 76. In FIG. 2B the cross-brace 84″ comprises a substantially longitudinal planer member attached to opposing sides of the main body 10 and having the ratchet and pawl housing attached to the cross-member at a point approximately equidistant from the opposing sides of the main body. In an exemplary embodiment, the cross-brace 84″ and ratchet and pawl housing 80 may comprise an integral structure connecting the pawl 76 to the main body 10 and allowing the ratchet 64 to slide over the cross-brace 84″, while engaging the pawl 76, thereby helping to support the ratchet 64. Thus, the cross-brace 84, 84′, 84″ may connect the pawl 76 to the main body 10 by use of a substantially longitudinal planer member (e.g., FIG. 2B), at least one rigid cylindrical member (e.g., FIG. 1), at least two rigid cylindrical members (e.g., FIG. 2A), a plurality of rigid members, or a combination thereof, and the cross-brace 84, 84′, 84″ may connect to the main body 10 by contacting the inner walls of the opposing sides of the main body 10 or on the bottom of the opposing sides of the main body 10. The purpose of the cross-brace 84 is to hold the pawl 76 and/or the ratchet and pawl housing 80 in a stationary position relative to the main body 10 regardless of whether the lifting arms 30 are raised or lowered. By holding the pawl 76 stationary and moving the ratchet 64 substantially parallel to the direction of the main body 10, the height of the locking system can be decreased and the pawl 76 and ratchet 64 can be maintained in an actively engaging position throughout the lifting motion and movement of the lifting arms 30. The invention also allows for the mounting of a pawl 76, or a ratchet and pawl housing 80, to the main body 10 at a position vertically lower than the position of the ratchet 64, thereby allowing more room within the main body 10 for retraction of the lifting arms 30. For example, the ratchet and pawl housing 80 and ratchet 64 shown in FIG. 2A may be inverted such that the ratchet and pawl housing 80 is below the ratchet 76. The pawl 76 is preferably elastically encouraged in a ratchet 76 engaging direction or into a ratchet engaged position.

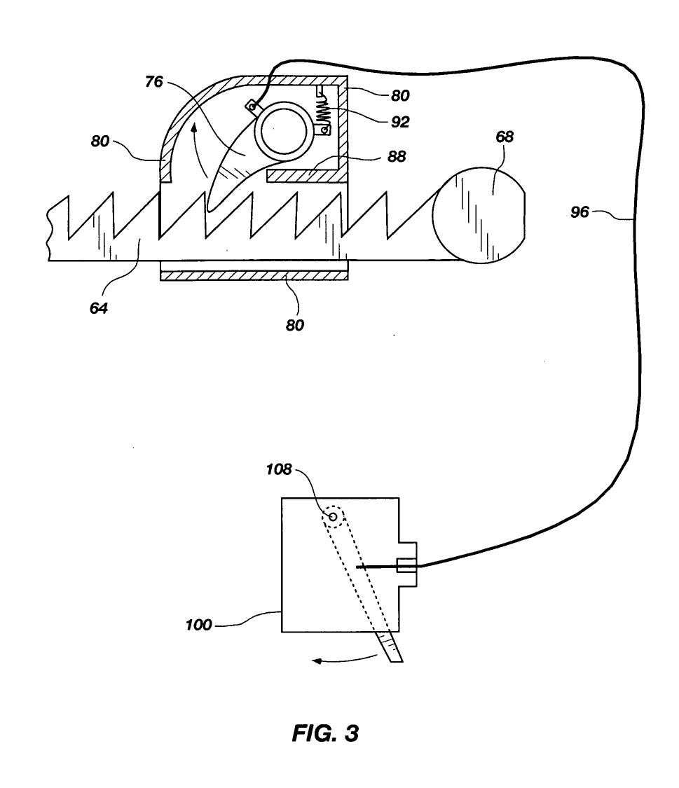

FIG. 3 provides a cross-sectional view of an exemplary ratchet and pawl housing 80 wherein the ratchet and pawl housing 80 optionally comprises a rigid member 88 or other means for restraining rearward travel of the pawl 76, thereby preventing retraction of the ratchet 64 and consequently the lifting arms 30. In an exemplary embodiment, the locking force of the ratchet 64 on the pawl 76 may travel substantially along the pawl 76, which is connected to the main body 10, thereby decreasing the profile of the safety device and allowing it to be adapted to low profile jacks. In this configuration the pawl 76 illustrated in FIG. 3A engages teeth 65 on the ratchet 64 at an angle ø less than or equal to about 45 degrees, less than or equal to about 40 degrees, less than or equal to about 35 degrees, less than or equal to about 30 degrees, less than or equal to about 25 degrees. In another exemplary embodiment, the ratchet and pawl housing 80 is less than about 4 inches tall, less than about 3.5 inches tall, less than about 3 inches tall, less than about 2.5 inches tall, less than about 2 inches tall, less than about 1.5 inches tall. While FIG. 3 illustrates a rigid member 88 as one possible means for achieving a maximal rearward travel position for the pawl 76, other means are known in the art. In addition, the invention allows for the pawl 76 to be positioned such that it engages the ratchet 64 at a low angle ø such that the restraining force along the pawl 76 is substantially parallel to the pawl 76, thereby increasing the structural soundness of the invention and providing for a lower profile jack. In addition, the pawl 76 of the present invention may optionally be placed under tension, for example, by means of an elastically reciprocating member 92, such that the pawl 76 actively engages the ratchet 64.

While the ratchet and pawl housing 80 in FIGS. 1, 2, and 3 are illustrated in the form of a ratchet and pawl housing 80 having at least four wall portions, the ratchet 64 and/or pawl 76 need not be in a ratchet and pawl housing 80 and any configuration of a ratchet and pawl housing 80 may be adapted to the invention, so long as the ratchet 64 and pawl 76 prevent retraction of the lifting mechanism 50 and/or lifting arms 30.

FIG. 3 also illustrates a elastically reciprocating member 92, or spring, that holds the pawl 76 in a ratchet engaging position, whereas linkage 96 is connected to the pawl 76, either directly or indirectly, and is used to move the pawl 76 into a ratchet releasing position by moving the pawl 76 in the direction of the arrow.

In the exemplary embodiment of FIG. 3, the pawl 76 is biased toward an engaging position by an elastically reciprocating member 92, e.g., a resilient spring, and is moved to a release position by a linkage 96 adapted to overcome the elastically reciprocating member 92 bias and move the pawl 76 to a release position under manual actuation at a location remote from the pawl 76. In particular, the invention allows a remote actuation site 100 to be situated on the handle 104 of the jack. In this embodiment the jack operator may disengage the pawl 76 at an acceptable distance from the main body 10 of the jack.

In another exemplary embodiment, the remote actuation site 100 comprises a housing 109 and a release lever assembly 108 connected to the linkage 96, mounted on the handle of the jack 104 and configured to actuate the linkage 96, e.g., a flexible cable, such as a steel wire, thereby moving the pawl 76 to a release position. When the release lever assembly 108 is moved to the locking position, the elastically reciprocating member 92 returns the pawl 76 to an engagement position. As will now be apparent, the remote actuation site 100 may be mounted or mountable at any desired position on the handle 104, preferably at or near the distal end of the handle 104. Optionally, the remote actuation site 100 may be detachably mounted on the handle 104 of the jack. While the remote actuation site 100 is illustrated as a release lever assembly 108, any suitable means of actuating the linkage 96 may be used, including, but not limited to, a pull cable system wherein the linkage 96 terminates in a handle, a lever where the pawl is biased to a ratchet engaging position and squeezing the lever moves the pawl to a ratchet releasing position (e.g., similar to those used on a motorcycle activate the clutch or brakes), or other mechanisms known in the art.

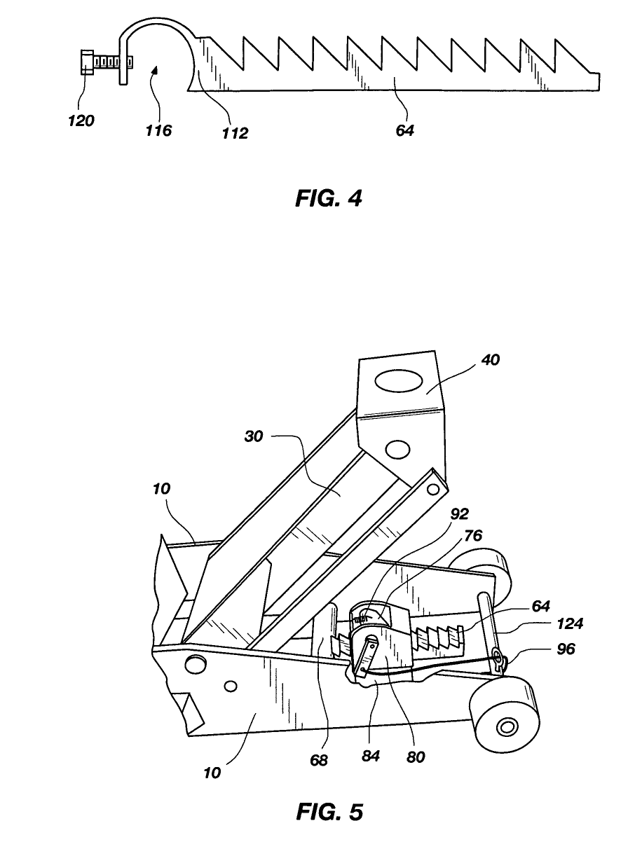

In the exemplary embodiment of FIG. 4, the ratchet is adapted to be rigidly connected to the bar 68 (FIG. 1) in a pre-assembled jack. For example, a proximal end 112 of a ratchet 64 is configured to have a channel 116 capable of rigidly engaging the bar 68 and/or ram 72. Optionally, a tensioning means 120 may be present so as to prevent rotation of the ratchet 64 when mounted on the bar 68. In another exemplary embodiment, the ratchet and pawl housing 80 is configured to replace a rigid member mounted substantially perpendicular to the two walls of the main body 10. For example, the ends of cross-brace 84 (e.g., FIGS. 1 and 2A) connected to the ratchet and pawl housing 80 may be threaded and secured to the main body 10 by way of a nut or other threaded locking means. Thus, the invention provides a kit adapted to add a locking system to a pre-assembled jack, wherein the kit may optionally include a ratchet 64, a pawl 76, a linkage 96, and a remote actuation site 100, optionally including a release lever assembly 108 configured to be secured to the handle 104 of the jack.

In another exemplary embodiment, the pawl 76 is configured such that it provides a low profile within the main body 10 of the jack. In another exemplary embodiment, the pawl 76 is configured such that the locking force of the ratchet 64 and pawl 76 is transferred substantially parallel to the direction of the pawl 76, thereby decreasing the profile of the safety device and placing less shear or breakage pressure on the pawl 76.

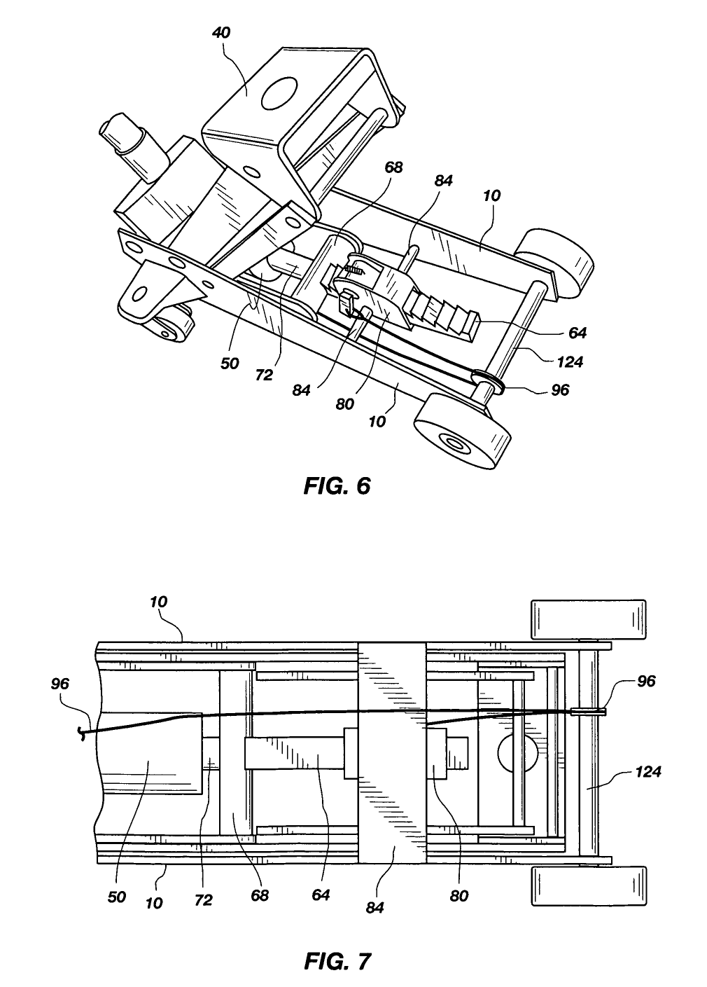

FIGS. 5, 6 and 7 show an exemplary embodiment of the invention. In this embodiment, the ratchet 64 is welded to the bar 68, and the ratchet and pawl housing 80, including the ratchet 76, is connected to the main body 10 by means of at least one cross-member 84. The linkage 96 is connected to the pawl 76, for example by way of a rigid member in communication with the pawl 76, such that the linkage 96 can disengage the pawl 76 from the ratchet 64, then allow the pawl 76 to return to an engaging position when desired. The linkage 96 may include any number of guide paths, such as a port (e.g., eyelet in FIG. 5) or a wheel or groove (e.g., FIGS. 6 and 7) to allow manual release of the safety device at a desirable distance from the jack.

All references, including publications, patents, and patent applications, cited herein are hereby incorporated by reference to the same extent as if each reference were individually and specifically indicated to be incorporated by reference and were set forth in its entirety herein.

While this invention has been described in certain embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A safety device for a jack comprising:
a pawl rigidly affixed to a main body of a jack;
a ratchet rigidly affixed to a lifting arm of the jack and having a plurality of teeth configured to engage the pawl, wherein raising the lifting arm of the jack causes the ratchet to travel substantially parallel to a main body of the jack and advance past the rigidly affixed pawl as the lifting arm is raised, wherein engagement of the pawl with the teeth of the ratchet positively restricts downward movement of the lifting arm when a lifting force is removed from the lifting arm.

2. The safety device of claim 1, wherein the pawl is biased to a ratchet engaging position.

3. The safety device of claim 1, wherein the pawl engages the ratchet at an angle of less than or equal to about 45 degrees.

4. The safety device of claim 1, wherein the main body of the jack comprises substantially parallel opposing walls and the pawl is rigidly affixed approximately equidistant from either opposing wall.

5. The safety device of claim 1, wherein the pawl is within a ratchet and pawl housing.

6. The safety device of claim 5, wherein the ratchet and pawl housing is rigidly affixed to a main body of the jack by at least one cylindrical metal rod or at least one substantially longitudinal member.

7. The safety device of claim 1, wherein the pawl is rigidly affixed to the main body of the jack by at least one cylindrical metal rod or at least one substantially longitudinal member.

8. The safety device of claim 1, wherein the pawl is a counter weighted pawl.

9. The safety device of claim 1, wherein the jack comprises a handle having an end in communication with the lifting mechanism and a distal end, and wherein the safety device further comprising a linkage connecting the pawl to a remote actuation site located at or near the distal end of the handle.

10. The safety device of claim 9, wherein the remote actuation site comprises a lever arm in communication with the linkage.

11. The safety device of claim 10, wherein the remote actuation site comprises the linkage connected to a lever pivotally attached to a remote actuation site housing.

12. The safety device of claim 11, wherein the lever is configured to be squeezed by the operator to move the pawl to a ratchet releasing position.

13. The safety device of claim 11, wherein the lever is configured to retain the pawl in a ratchet releasing position.

14. The safety device of claim 11, further comprising a pawl engagement biasing force acting on the linkage to hold the lever arm in a ratchet and pawl locking position.

15. The safety device of claim 9, wherein the linkage comprises a metal wire.

16. The safety device of claim 9, wherein the linkage is passively guided down the handle.

17. The safety device of claim 16, wherein the remote actuation site comprises a distal end of the linkage connected to a handle.

18. A hydraulic floor jack with a safety system, jack comprising:
a hydraulic floor jack having at least two lifting arms, a hydraulic lifting system in communication with the at least two lifting arms, a main body comprising two substantially parallel outer walls and having a front end designed to face the object to be lifted and a rear end, and a handle with one end in communication with the hydraulic lifting system and a second end located distal to the main body;
the main body having a rigid member extending between the two outer walls near the front end of the jack and wherein the hydraulic lifting system is located at the rear of the main body;
a ratchet rigidly affixed to the at least two lifting arms and having a plurality of teeth;
a pawl pivotally connected to the main body between the two substantially parallel outer walls, wherein the pawl is configured to actively engage the ratchet as the lifting arms are raised; and
a linkage cable connecting the pawl to a housing located on the distal end of the handle.

19. The hydraulic floor jack with a safety system of claim 18, wherein a spring configures the pawl to actively engage the ratchet.

20. The hydraulic floor jack with a safety system of claim 19, wherein a lever arm is configured to move the pawl to a ratchet releasing position.

21. The hydraulic floor jack with a safety system of claim 18, wherein the linkage cable is a pull cable system.
